(19) United States
(12) Patent Application Publication
(10) Pub. No.: US 2020/0388139 A1
(43) Pub. Date: Dec. 10, 2020

(54) CONTINUOUS DETECTION AND RECOGNITION FOR THREAT DETERMINATION VIA A CAMERA SYSTEM

(71) Applicant: Ooma, Inc., Sunnyvale, CA (US)

(72) Inventors: Shamindra Saha, Castro Valley, CA (US); Paxshal Mehta, Milpitas, CA (US); Govind Vaidya, San Ramon, CA (US)

(21) Appl. No.: 16/434,576

(22) Filed: Jun. 7, 2019

(51) Int. Cl. G08B 21/18; G08B 27/00; H04N 7/18; G06K 9/00; G06N 5/00

(52) U.S. Cl. CPC G08B 21/182; G08B 27/005; G06N 5/003; H04N 7/188; G06K 9/00536; H04N 7/185

(57) ABSTRACT

Systems and methods for continuously recognizing and determined a threat level via a smart camera system are described herein. A camera located in a physical space may recording video and/or audio for a predetermined amount of time. The recorded video may be processed to determine a background, activity, identify human faces, and expressions, and evaluate those inputs to determine a predictive threat level to persons and/or property present in the physical space where the camera is located.

### CROSS-REFERENCE TO RELATED APPLICATION

N/A

### TECHNICAL FIELD

The present disclosure relates to systems and methods to preemptively determine that a potential activity observed via a camera system is a potential threat and determine a severity level of the potential threat.

### BACKGROUND

Security cameras have been widely deployed in physical spaces for many years. However, security cameras are not able to automatically process recorded video in substantially real-time, to identify a potential threat present. Typically, a human is required to view the video to determine if a threat is present. The present disclosure provides for mechanisms for continuous monitoring of a threat level via a camera system.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are processor-implemented systems and methods for continuously monitoring and detecting threats to persons or property, via a smart camera system. In exemplary embodiments, when a camera located in a physical space it begins recording video for a predetermined length of time. Substantially simultaneously, the video frames can be processed to detect and identify background(s), background activities, foreground activity, human faces, objects, and human facial expressions. Each of these elements is analyzed in combination to determine whether a potential threat is present and the severity of the potential threat. Results of the analysis are presented to a user via a user computing device.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings, in which like references indicate similar elements.

FIG. 1 illustrates an environment within which systems and methods of the present disclosure can be implemented, according to example embodiments.

FIG. 2 illustrates an exemplary camera that can be used for continuous detection and recognition for threat determination via the disclosed camera system.

FIG. 3 is a block diagram showing various components of a video analysis system for processing captured video, in accordance with certain embodiments.

FIG. 4 is a block diagram showing various components of a system for facial recognition, in accordance with certain embodiments.

FIG. 5 is a block diagram showing various components of a threat determination system, in accordance with certain embodiments.

FIG. 6 is a block diagram showing various modules of a threat determination system, in accordance with certain embodiments.

FIG. 7 is a process flow diagram showing a method for threat determination via a camera system, according to an example embodiment.

FIG. 8 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The disclosure relates to a system and methods for facilitating continuous detection and recognition of threats via a camera system. More specifically, the system allows a consumer-friendly camera to be deployed in any one or more indoor physical space (such as a bedroom, living room, office, etc.) and/or one or more of any outdoor physical space (such as a patio, backyard, parking lot, etc.). The camera, through use of specially designed hardware and specially programmed software, can record video clips of any duration when a triggering activity is detected by one or more sensors on the camera, and/or by a microphone on the camera. The camera may transmit captured video, audio, and/or other data from its sensors, through a Network to a video analysis system, which contains software operating on a remote server (such as in a cloud server).

The video analysis system can analyze information received from the camera in substantially real-time to determine a likelihood that a threatening activity is occurring in the space where the camera is located. The software may determine a threat level and send an alert to a user of the camera system with the generated threat level. In some embodiments, the alert sent to the user of the camera system may also include one or more of a copy of a video clip where the potentially threatening activity was detected, a copy of an audio sound recorded, or information regarding measurements from other sensors on the camera. The user may then confirm that the determined threat level by the video analysis system is indeed accurate, the determined threat level needs to be higher or lower, or that the recorded activity is not actually a threat after all. Through this feedback, the video analysis system continuously learns information about people, objects, and activities occurring in the physical space where one or more connected cameras are located. With this learned information, the video analysis system can continuously monitor for, and accurately detect, potentially threatening activity that is occurring in a physical space where a camera is located, in substantially real-time.

In some embodiments, pre-processing software operating on the camera itself can mark specific video frames that contain a human face. Recorded video folders have additional information on frame(s) containing human faces so that further analysis of these frames can be conducted. That is, while recording the video on the camera itself, individual frames are processed simultaneously in camera firmware and a metadata file is generated and updated with information regarding the specific video frame(s) in which a human face was detected. The recorded video along with the metadata information is transmitted to facial recognition software for further analysis. The facial recognition software may operate via a processor separate from the camera itself, such as on a separate connected server in a cloud or elsewhere.

A typical facial recognition method processes an entire video clip to detect and recognize faces, which is time consuming and significantly increases the compute power required. In embodiments of the present disclosure, video analysis software processes the recorded video, extracts the frames that have been previously marked by the camera as containing a human face, and applies facial recognition algorithm(s) to those selected video frames. That is, instead of performing facial recognition analysis on the entire video clip, the video analysis software processes the metadata file from the camera and carries out further facial analysis on the selective frames identified in the metadata file. This unique method significantly reduces the compute time and storage resources required. The results of the further facial analysis may constitute facial recognition information, which may then be transmitted to a threat determination system of the camera system, to aid in determining a threat level to persons or property present in a physical space where the camera is located.

By bifurcating the facial detection and facial recognition processes, the camera itself can be manufactured at a consumer-friendly price point, and deployed by a consumer quickly and easily in a physical space. Further, by pre-processing some video clips in the camera firmware itself, only selected video frames need to be analyzed by the software algorithm for recognizing the detected faces. This significantly reduces the computing burden and time for the facial recognition process, as well as significantly reducing the computing storage resources necessary. Further, this allows the facial recognition analysis to occur quickly, in substantially real-time. Thus, if an unrecognized face is detected in the video clip, a user can be alerted quickly and take appropriate action in a timely manner.

In other embodiments, the camera can identify specific video frames that contain a known object other than a human. For example, a camera can identify video frames containing another body part of a human, a body part of an animal, and/or an inanimate object.

In further embodiments, pre-processing software operating on the camera itself can mark specific video frames that contain a particular known object that is deemed potentially threatening. For example, while recording the video on the camera itself, individual frames may be processed simultaneously in camera firmware and a metadata file generated and updated with information regarding the specific video frame(s) in which a potentially threatening person (such as a known threatening person), object (such as a weapon), or sound (such as a gunshot) was detected. The video analysis software may then process the metadata file from the camera and carry out further analysis on the selective frames identified in the metadata file to determine an actual threat level posed by the person, object, or sound, in view of the context. That is, other factors such as background of the video frame(s), sound level, luminosity of light in the video frame(s), motion, etc. can be further utilized to generate a predictive threat level.

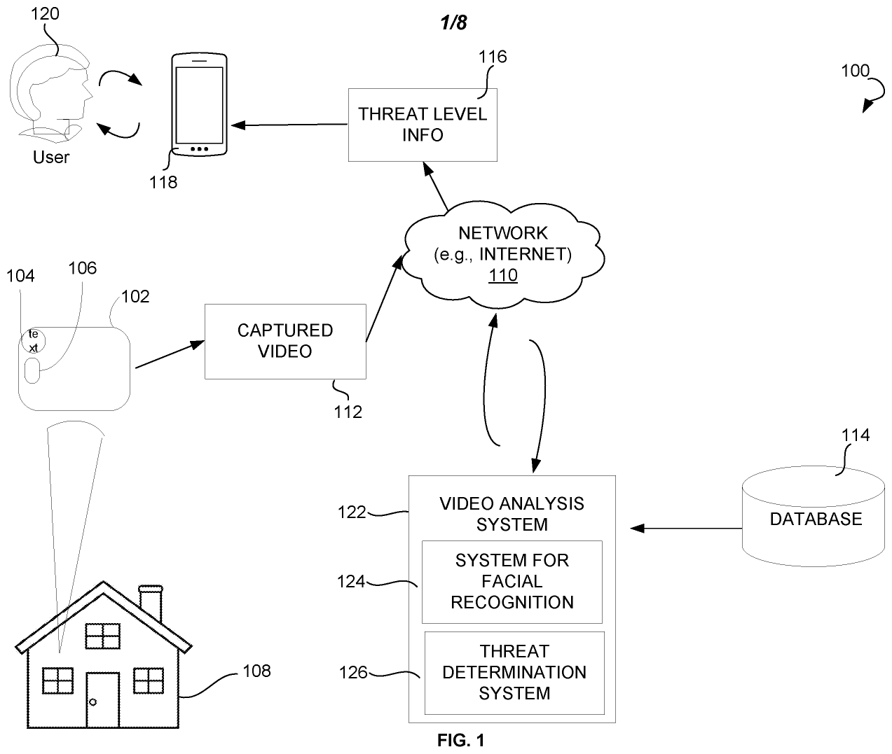

FIG. 1 illustrates an environment 100 within which systems and methods for automatic continuous detection and recognition for threat determination via a camera system can be implemented, in accordance with some embodiments. The environment 100 may include a camera 102 containing a camera lens 104, and camera sensor(s) 106. The camera 102 may be deployed in a physical space 108, such as a house. Though not explicitly shown in exemplary FIG. 1, camera 102 also has one or more additional components in various embodiments, that enable its operation for the purposes of the present disclosure.

The captured video 112 from the camera 102 may be transmitted via a network 110 to a cloud video analysis system 122, which may include a system for facial recognition 124 and a threat determination system 126. The cloud video analysis system 122 may further utilize data structures (such as database 114) and one or more computing processors and volatile and non-volatile memory.

After processing captured video 112, the system for facial recognition 124 may generate facial recognition information, which in turn is utilized by the threat determination system 126 to generate threat level information 116. The threat level information 116 is then transmitted through network 110 to an application operating on a user device 118 or a web browser operating on user device 118, which in turn can be viewed by a user 120. Each of these components is discussed in further detail herein.

A camera 102 may be deployed in any physical space 108 to record audio, video, and/or other environmental characteristics around the physical space 108. While physical space 108 is depicted in exemplary FIG. 1 as a house, a person of ordinary skill in the art will understand that camera 102 may be deployed in any indoor physical space, such as a room or hallway in a residence, a room or hallway in a non-residential building, or any other space. The camera 102 may also be located in any outdoor physical space, such as a patio, backyard, front yard, parking lot, parking garage, etc. Further, while only one camera 102 is depicted in FIG. 1 for simplicity, there can be any number of cameras in physical space 108. If multiple cameras are located in space 108, one or more of the cameras may be in wireless communication with one another, in exemplary embodiments. Further, while camera 102 is depicted in FIG. 1 as a standalone device, in other embodiments, camera 102 may be incorporated as a part of other electronic devices. For example, camera 102 may be incorporated as part of a smartphone, tablet, intelligent personal assistant, or other smart electronic device.

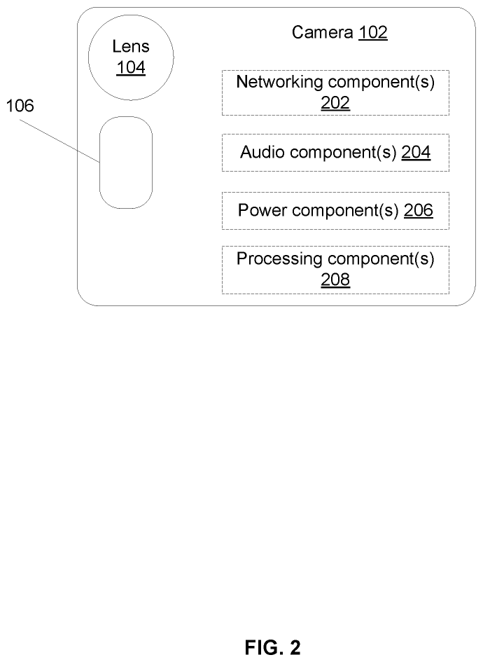

Camera 102 is described in further detail with respect to FIG. 2. In various embodiments, camera 102 is a consumer-friendly camera that can be utilized by a human user without needing to have any specialized camera expertise. The camera 102 may have one or more lens 104, with which video is captured. In exemplary embodiments, lens 104 may be any type of lens typically found in consumer cameras, such as a standard prime lens, zoom lens, and wide angle lens.

Camera 102 further has one or more sensors 106. Sensor(s) 106 may be any type of sensor to monitor conditions around the camera 102. By way of non-limiting example, sensor 106 may comprise one or more of a PIR (passive infrared) sensor that can bring to life colored night vision, a motion sensor, a temperature sensor, a humidity sensor, a luminosity sensor to measure light levels, a GPS, etc. As would be understood by persons of ordinary skill in the art, other types of sensors can be utilized to monitor other types of conditions as well around camera 102.

Referring to FIG. 2, camera 102 has additional components that enable its operation. For example, camera 102 may have power component(s) 206. Power component(s) 206 may comprise an electrical connector interface for electronically coupling a power source to, or for providing power to the camera 102. Electrical connector interface may comprise, for example, an electrical cable (the electrical cable can be any of a charging cable, a FireWire cable, a USB cable, a micro-USB cable, a lightning cable, a retractable cable, a waterproof cable, a cable that is coated/covered with a material that would prevent an animal from chewing through to the electrical wiring, and combinations thereof), electrical ports (such as a USB port, micro-USB port, microSD port, etc.), a connector for batteries (including rechargeable battery, non-rechargeable battery, battery packs, external chargers, portable power banks, etc.), and any other standard power source used to provide electricity/power to small electronic devices.

In an exemplary embodiment, power component(s) 206 comprises at least one battery provided within a housing unit. The battery may also have a wireless connection capability for wireless charging, or induction charging capabilities.

Camera 102 also comprises audio component(s) 204. In various embodiments, audio component(s) 204 may comprise one or more one-way or two-way microphones for receiving, recording, and transmitting audio.

Camera 102 further has processing component(s) 208 to enable it to perform processing functions discussed herein. Processing component(s) 208 may comprise at least one processor, static or main memory, and software such as firmware that is stored on the memory and executed by a processor. Processing component(s) 208 may further comprise a timer that operates in conjunction with the functions disclosed herein.

In various embodiments, a specialized video processor is utilized with a hardware accelerator and specially programmed firmware to identify triggering events, begin recording audio and/or video (in either Standard Definition or High Definition), cease recording of audio and/or video, process the captured video frames and insert metadata information regarding the specific video frame(s) containing an identified potentially threatening object or activity, and transmit the recorded audio, video, and metadata to a video analysis system 122 operating via software in a cloud computing environment.

Camera 102 also comprises networking component(s) 202, to enable camera 102 to connect to network 110 in a wired or wireless manner, similar to networking capabilities utilized by persons of ordinary skill in the art. Further, networking component(s) 202 may also allow for remote control of camera 102.

In various embodiments, the networking communication capability of camera 102 can be achieved via an antenna attached to any portion of camera 102, and/or via a network card. Camera 102 may communicate with network 110 via wired or wireless communication capabilities, such as radio frequency, Bluetooth, ZigBee, Wi-Fi, electromagnetic wave, RFID (radio frequency identification), etc.

A human user 120 may further interact with, and control certain operations of the camera 102 via a graphical user interface displayed on a user device 118. The graphical user interface can be accessed by a human user 120 via a web browser on the user device 118 (such as a desktop or laptop computer, netbook, smartphone, tablet, etc.). A human user may further interact with, and control certain operations of the camera 102 via a dedicated software application on a smartphone, tablet, smartwatch, laptop or desktop computer, or any other computing device with a processor that is capable of wireless communication. In other embodiments, a human user 120 can interact with, and control certain operations of the camera 102 via a software application utilized by the user 120 for controlling and monitoring other aspects of a residential or non-residential building, such as a security system, home monitoring system for Internet-enabled appliances, voice assistant such as Amazon Echo, Google Home, etc.

Returning to FIG. 1, camera 102 captures video as discussed herein. The captured video 112 is then transmitted to video analysis system 122 via network 110.

The network 110 may include the Internet or any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection.

Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network can further include or interface with any one or more of an RS-232 serial connection, an IEEE-1394 (FireWire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking.

The network 110 may be a network of data processing nodes that are interconnected for the purpose of data communication. The network 110 may include any suitable number and type of devices (e.g., routers and switches) for forwarding commands, content, requests, and/or responses between each user device 118, each camera 102, and the video analysis system 122.

The video analysis system 122 may include a server-based distributed software application, thus the system 122 may include a central component residing on a server and one or more client applications residing on one or more user devices and communicating with the central component via the network 110. The user 120 may communicate with the system 122 via a client application available through the user device 118.

Video analysis system 122 may comprise software application(s) for processing captured video 112, sensor data, as well as other capabilities. Video analysis system 122 is further in communication with one or more data structures, such as database 114. In exemplary embodiments, at least some components of video analysis system 122 operate on one or more cloud computing devices or servers.

Video analysis system 122 further comprises a system for facial recognition 124 and a threat determination system 126. The system for facial recognition 124 analyzes the specific video frames noted in metadata associated with captured video 112. Through the analysis, which consists of one or more software algorithms executed by at least one processor, the system for facial recognition 124 analyzes the video frames from captured video 112 that have been noted as containing a human face. The human face detected in each video frame is then “recognized”, i.e., associated with a likely name of the person whose face is detected.

Face recognition information, which may comprise a name of one or more people recognized in captured video 112 is then utilized by threat determination system 126 to determine a threat level of an activity occurring near camera 102. This threat level information 116 is then transmitted through network 110, to a user device 118, at which point it can be viewed by user 120. In some embodiments, additional information may be transmitted with threat level information 116, such as a copy of an image, video clip, audio clip, or other sensor information associated with captured video 112.

Threat level information 116 is displayed via a user interface on a screen of user device 118, in the format of a pop-up alert, text message, e-mail message, alert sound, or any other means of communicating with user 120.

In some embodiments, threat level information 116 may be any one or more of a numerical value, a text value, a color, or a graphic symbol. For example, threat determination system may determine a potential threat and categorize it into of a plurality of threat level categories. Color-coded threat levels may indicate a severity of threat category. In one example, green may indicate that no threatening activity has been detected by camera 102. Yellow may indicate a general warning, amber may indicate a serious warning, and red may indicate that an emergency scenario has been detected by camera 102.

In other embodiments, threat level information 116 may be a numerical value that is uncategorized, allowing user 120 to formulate their own judgment as to the severity of the threat level of activity occurring near camera 102. For example, threat level information 116 may be a number between 0-5, a number between 0-10, 0-100, or any other configurable scale.

In further embodiments, threat level information 116 may appear as a graphical icon on a screen of user device 118 of any color, to indicate a category of threat level. That is, a different graphical icon may represent different threat level categories. Typically, there may be 2-6 categories for categorizing a threat level by threat determination system 126.

Further, user 120 may customize and configure the number of threat categories and criteria for determining threat category by threat determination system 126. In one example, user 120 may configure threat determination system 126 to automatically assign the most severe threat category anytime a gun is detected by camera 102. In another example, user 120 may configure threat determination system 126 to automatically assign the most severe threat category anytime a particular person is detected by camera 102.

In a further example, user 120 may be an avid hunter, and thus configure threat determination system 126 to automatically assign only a cautionary threat level when a gun is detected by camera 102. Further, user 120 may practice wood carving as a hobby and thus configure threat determination 126 to assign only a cautionary threat level or the least severe threat level when a knife is detected in one particular room where user 120 practices wood carving, but not when detected in other physical spaces or backgrounds by camera 102.

The user device 118, in some example embodiments, may include a Graphical User Interface for displaying the user interface associated with the system 122. The user device 118 may include a mobile telephone, a desktop personal computer (PC), a laptop computer, a smartphone, a tablet, a smartwatch, intelligent personal assistant device, smart appliance, and so forth.

In some embodiments, camera 102 may be continuously recording and transmitting captured video 112 to video analysis system 122. In other embodiments, camera 102 may record a predetermined amount of time (such as 10 seconds) and analyze the captured video 112 and/or sensor data either through processing on the camera 102 itself, or by video analysis software 122. The short recorded video clip may be analyzed to see if there is a need to continue recording or not. For example, camera 102 may continue recording if any activity is detected, if a certain sensor threshold has been crossed, if a certain threat level is predicted, or any other configurable threshold. In other embodiments, camera 102 may utilize activity-based recording, where camera 102 is triggered on with the occurrence of a triggering event, and then continues to record for a predetermined amount of time.

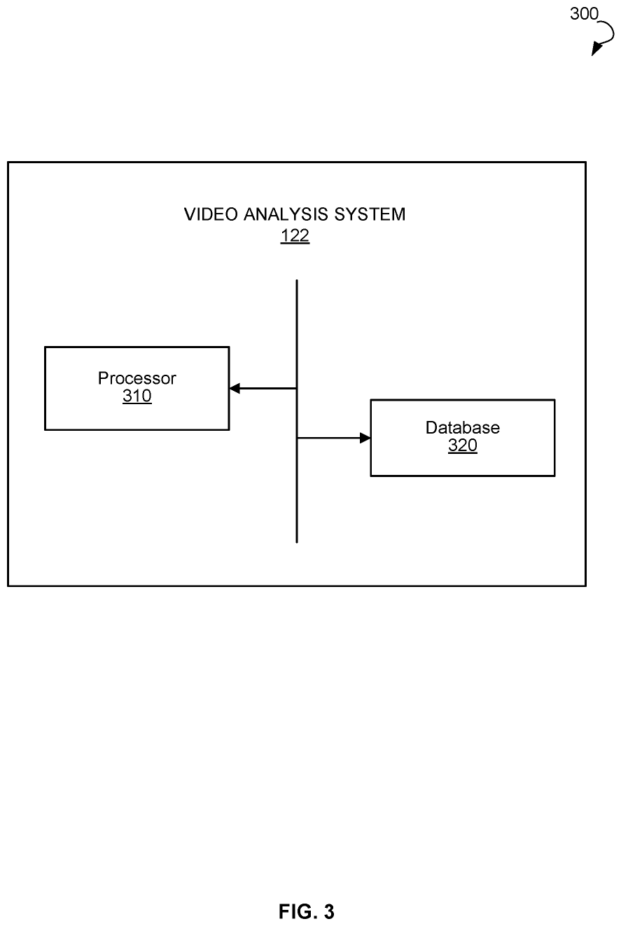

FIG. 3 is a block diagram showing various modules of a video analysis system 122 for processing captured video 112, in accordance with certain embodiments. The system 112 may include a processor 310 and a database 320. The database 320 may include computer-readable instructions for execution by the processor 310. The processor 310 may include a programmable processor, such as a microcontroller, central processing unit (CPU), and so forth. In other embodiments, the processor 310 may include an application-specific integrated circuit or programmable logic array, such as a field programmable gate array, designed to implement the functions performed by the system 122. In various embodiments, the system 122 may be installed on a user device or may be provided as a cloud service residing in a cloud storage. The operations performed by the processor 310 and the database 320 are described in further detail herein.

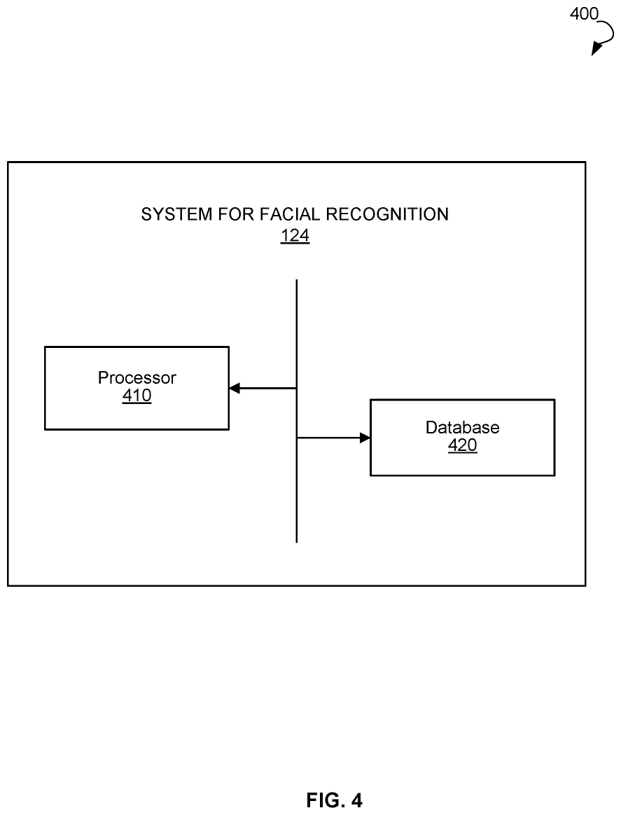

FIG. 4 is a block diagram showing various modules of a system for facial recognition 124, for identifying (recognizing) detected human faces in select frames of captured video 112, in accordance with certain embodiments. The system 124 may include a processor 410 and a database 420. The processor 410 of system for facial recognition 124 may be the same, or different from processor 310 of the video analysis system 122. Further, database 420 of system for facial recognition 124 may be the same or different than database 320 of video analysis system 122.

Database 420 may include computer-readable instructions for execution by the processor 410. The processor 410 may include a programmable processor, such as a microcontroller, central processing unit (CPU), and so forth. In other embodiments, the processor 410 may include an application-specific integrated circuit or programmable logic array, such as a field programmable gate array, designed to implement the functions performed by the system for facial recognition 124. In various embodiments, the system for facial recognition 124 may be installed on a user device or may be provided as a cloud service residing in a cloud storage. The operations performed by the processor 410 and the database 420 are described in further detail herein.

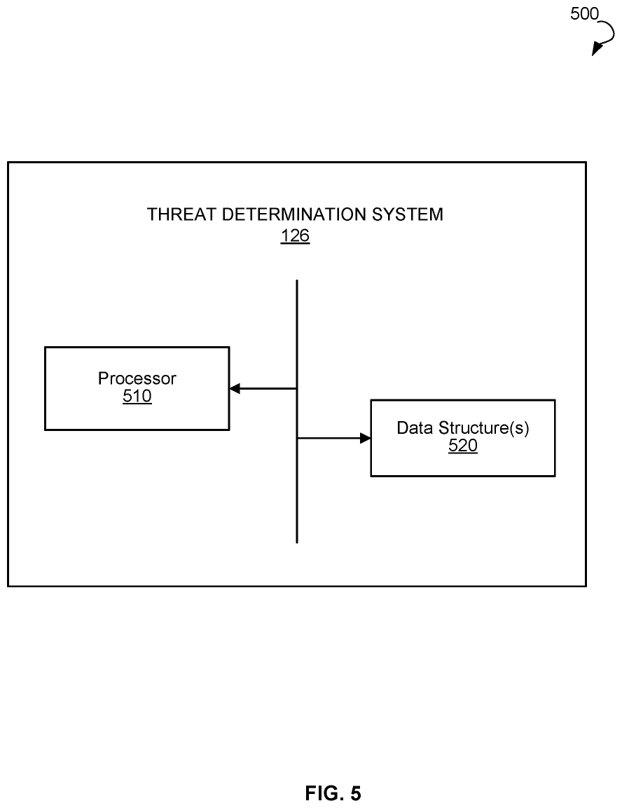

FIG. 5 is a block diagram showing various modules of a threat determination system 126, for determining a threat level of an object, person, or activity from select frames of captured video 112, in accordance with certain embodiments. The system 126 may include a processor 510 and data structure(s) 520. The processor 510 of system 126 may be the same, or different from processor 410 of the system for facial recognition 124, and/or processor 310 of the video analysis system 122. Data structure(s) 520 may include one or more decision trees, databases, or any other data structure. Data structure(s) 520 may utilize a database that is the same or different from database 420 of system for facial recognition 124 and/or database 320 of video analysis system 122.

Data structure(s) 520 may include computer-readable instructions for execution by the processor 510. The processor 510 may include a programmable processor, such as a microcontroller, central processing unit (CPU), and so forth. In other embodiments, the processor 610 may include an application-specific integrated circuit or programmable logic array, such as a field programmable gate array, designed to implement the functions performed by the threat determination system 126. In various embodiments, the threat determination system 126 may be installed on a user device or may be provided as a cloud service residing in a cloud storage. The operations performed by the processor 510 and the data structure(s) 520 are described in further detail herein.

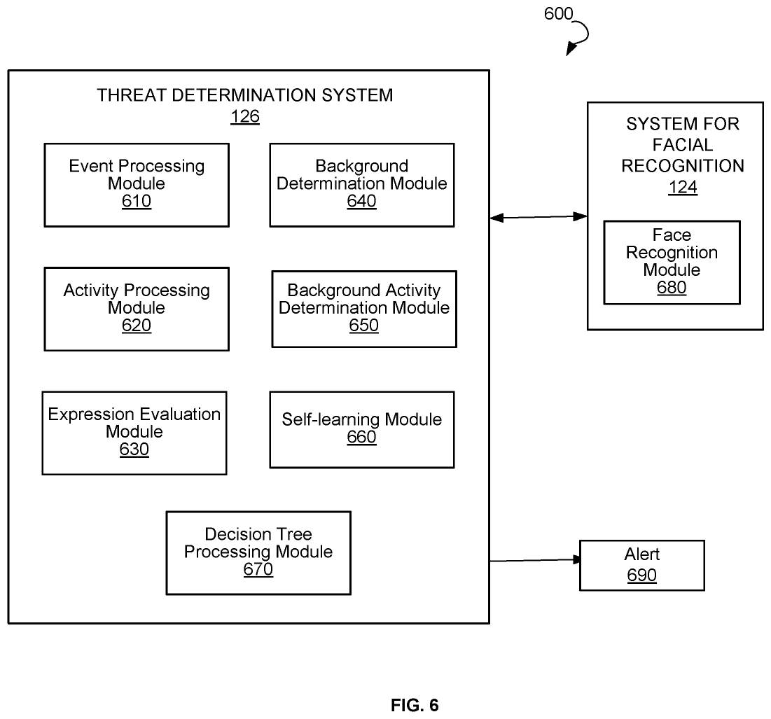

FIG. 6 depicts an exemplary environment 600 within which threat determination system 126 operates. As depicted in the exemplary figure, threat determination system 126 has a number of modules that operate within it. While these exemplary modules are depicted in FIG. 6, it would be understood that other embodiments of threat determination system 126 may have fewer or additional modules than those depicted in the figure. Each of the modules may be discrete processes operating on a same or different processor from one another. Further, each of the modules may be discrete pieces of software operating on a computing device as discussed herein, that may communicate with one or more other modules.

Threat determination system 126 may have a background determination module 640. This module views what is happening in the background where camera 102 is placed, through what is picked up by camera lens in captured video 112. For example, background determination module 640 may figure out and detect the physical space 108 where camera 102 is placed based on identifying people and/or objects present in captured video 112.

The background determination module 640 may take into account various factors in determining where camera 102 is placed, such as a number of people, movement of people, detection of specific known objects, detection of grass, noise level, luminosity level, etc. of a background. If camera 102 is moved to a different physical location, then background determination module 640 may again utilized captured video and other sensor data to determine a background location where camera 102 is located. The background determination is a static determination of where camera 102 is located, until the camera 102 is moved to a different physical location.

Background determination module 640 may further utilize predefined background profiles to aid in determining a background location. For example, the presence of a bed detected in captured video 112 may indicate that camera 102 is in a bedroom. The presence of a vehicle may indicate that camera 102 is in a garage. The presence of a plurality of vehicles may indicate that camera 102 is in a parking structure. The presence of a stove may indicate that camera 102 is in a kitchen. The presence of grass may indicate that camera 102 is in an outdoor space. As would be understood by persons of ordinary skill in the art, any such criterion can be utilized and customized for background determination.

In addition, each detected background may be stored in data structure(s) 520 of threat determination system 126 with a unique identifier. Further, user 120 can name a background as well as customize key objects that would lead background determination module 640 to determine the camera 102 is in a particular background.

Background activity determination module 650 uses captured video and/or sensor data from camera 102 to determine any background activities that may be occurring near camera 102. This is a dynamic background determination. For example, background activity determination module 650 may determine that a group of people is present in a background and thus an event is likely going on, such as a meeting, or party. The background activity determination module 650 detects the occurrence of an activity occurring in a background. In some embodiments, user 120 can label the background activity as well, such as “party”, “meeting”, “playdate”, etc.

When camera 102 is first placed in a new physical space 108, the camera can capture PIR motions and videos. These are used by the camera system to learn a background for physical space 108 where camera 102 is placed and objects present in the space. From this, background determination module 640 and background activity determination module 650 can build reference points for backgrounds and background activities recorded over a set period of time (such as 6-48 hours). A user may configure an amount of time for camera 102 to record to build an initial reference set of backgrounds and background activities.

Activity processing module 620 may use captured video and/or sensor data from camera 102 to determine and distinguish one or more activities occurring in a foreground of camera 102. For example, activity processing module 620 may determine that a person is moving around the space, a group of people is moving around, an animal (such as a pet) is moving around, etc. Activity processing module 620 may focus on a particular proximity point to detect a main activity occurring in a foreground of the view from camera lens.

In some embodiments, activity processing module 620 may also log a time that an activity began, a time that an activity ended, a time of day (e.g., morning/night). In other embodiments, activity processing module 620 may communicate with system for facial recognition 124 to identify faces and determine whether the identified faces are known or unknown to the system.

Face recognition module 680 of system for facial recognition 124 may detect and identify faces in captured video from camera 102, utilizing systems and methods discussed herein. This information is communicated with threat determination system 126. If face recognition module 680 recognizes an unknown face, or a face that has never been detected before, it may tend to bias towards a more severe threat level. Contrarily, known faces or previously detected faces may bias system 126 towards a less severe threat level.

In some embodiments, user 120 may tag identified faces with a name or identifier. Further, user 120 may create and edit categories of known faces. For example, user 120 may create categories for recognized faces of family members, friends, co-workers, neighbors, service vendors, etc. As would be understood by persons of ordinary skill in the art, any number of categories can be created and maintained in face recognition module 680.

Further, user 120 may bias various categories of people towards differing threat levels. For example, faces recognized as belonging to a “family” category may be biased towards a less severe threat level, while faces recognized as belonging to an “acquaintance” category may be biased towards a more cautionary threat level, since user 120 does not know the people as well.

Expression Evaluation Module 630 operates in conjunction with face recognition module 680 to identify a facial expression present in the face of detected faces in captured video from camera 102. For example, a person that is smiling or laughing, indicating a happy mood, may bias towards a less severe threat level, even if the detected face is of an unknown person. On the other hand, an angry, frightened, or confused expression on a detected face may bias towards a more cautionary threat level. A different threat level may be assigned if the detected face with the negative expression is a known person versus an unknown person to user 120.

Further, expression evaluation module 630 may learn expressions from detected faces over time to more accurately determine various expressions that are typical or atypical for each person. That is, a detected face may have a scowl-like expression, but expression evaluation module 630 may repeatedly detect this expression on this recognized face over many non-threatening activities. As such, expression evaluation module 630 can learn that this particular expression on this particular person is not alarming, whereas it may be alarming on a different person for whom this is not a usual default expression. Additionally, a detected face with an unusual expression that has not been observed before may indicate that a more severe threat level is warranted.

Self-learning module 660 takes input from the other modules discussed herein—event processing module 610, activity processing module 620, expression evaluation module 630, background determination module 640, background activity determination module 650, and face recognition module 680 to continually learn and update examples of items that are threatening or non-threatening. Every person, object, background, and/or activity detected can be analyzed and indexed. Further, inputs from user 120 also assist self-learning module 660 to learn examples of typical people, objects, and activities in the physical space 108 where camera 102 is located, so that a more accurate determination can be made by threat determination system 126 as to the presence of threatening people, objects, and/or activities.

In various embodiments, a 3-dimensional graph of trees is utilized for each of the components—faces, expressions, events and activity. Every person detected, analyzed and indexed may have four trees of data: (1) face—recognizing the face, (2) expression—recognizing a facial expression present on the face, (3) activity—what the person is doing in the frame(s), and (4) background—where the person is located. These four trees of data that are generated per person are indexed and ranked based on level of harm by decision tree processing module 670, to generate a predictive threat level for a person detected by camera 102.

For example, if a known person is present is a known background space, but they are doing an unusual activity (like swinging around a knife), that may indicate that a higher threat level is warranted. If a known person is present with a neutral facial expression and doing a neutral activity like browsing their phone, but they are in an unusual background space (like an attic) where the person has not been previously detected, then that may indicate a higher threat level is warranted. If a known person is recognized in a usual background space and doing a neutral activity like walking, but a scared facial expression is detected, that may indicate that a potential threat is present in the physical space 108, either within view of the camera lens or outside view of the camera lens.

In a further example, a person may be working with a sawing tool in a garage, which may be a recognized activity for this person. If the person begins moving the tools in a different direction or different way than previously detected, then that may indicate that the person is utilizing the tool in a threatening manner. The decision tree processing module 670 may evaluate a threat level based on any one or more factors such as who the person is, what the person is doing, what the background is, how the background is being used, time, time of day, past history, etc. Threat determination system 126 may generate and send an alert 690 to user 120, who may then confirm the generated threat level, increase the generated threat level, or decrease the generated threat level. Through this user input, decision tree processing module 670 can improve its threat level prediction in future instances.

The trees of data are utilized by decision tree processing module 670 to determine and generate a predictive threat level in substantially real-time, for persons or property in the physical space 108 where camera 102 is located. As would be understood by persons or ordinary skill in the art, other data structures in addition to, or instead of, decision trees may be utilized by threat determination system 126 in various embodiments.

Decision tree processing module 670 determines the threat level, and may optionally also determine when to send alert 690 to user 120. That is, an emergency warning may be immediately transmitted to user 120, whereas a lower threat level may be transmitted to user 120 via alert 690 at certain predetermined intervals, or times of day. These predetermined intervals or times of day may further be configurable by user 120.

While embodiments have been described herein with respect to individuals, it would be understood by persons of ordinary skill in the art, that the disclosed embodiments are equally applicable to groups of people. Threat determination system 126 can analyze each individual in a group, as well as the group as a whole. For example, background activity determination module 650 can determine that a group of people in a background of a view of camera lens is talking, walking around, standing around, etc. Threat determination system 126 can tag faces in the identified group of people as being known to the system or unknown to the system.

Decision tree processing module 670 may determine that a group of people with mostly or entirely known faces is not likely to be a threat. However, continuous monitoring of the situation may change this determination. For example, there may be a debate or argument ensuring among two or more members of the group. As such, people may begin speaking louder due to arguing. This increased noise level may be picked up by a microphone on camera 102, and decision tree processing module 670 may determine a higher threat level is warranted for the ongoing situation. In another example, expression evaluation module 630 may detect that a facial expression on one or more people in the group has changed from a positive expression to a negative one. This may lead decision tree processing module 670 to increase the previously assigned threat level for the ongoing activity.

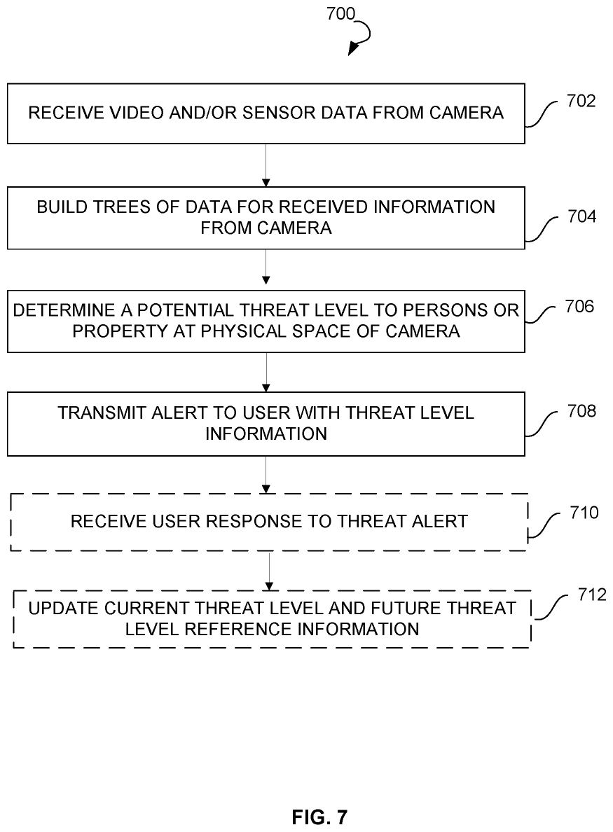

FIG. 7 is a process flow diagram showing a method 700 for automatic threat level determination via a camera system, within the environment described with reference to FIG. 1. In some embodiments, the operations may be combined, performed in parallel, or performed in a different order. The method 700 may also include additional or fewer operations than those illustrated. The method 700 may be performed by processing logic that may comprise hardware (e.g., decision making logic, dedicated logic, programmable logic, and microcode), hardware accelerator, software (such as firmware or other software run on a special-purpose computer system or general purpose computer system), or any combination of the above.

Various operations of method 700 may be performed by video analysis system 122, system for facial recognition 124, threat determination system 126, or any combination thereof.

The method 700 may commence at operation 702 with threat determination system 126 receiving recorded video and/or sensor data from camera 102. As discussed herein, the recorded video may be a video clip of any duration. In preferred embodiments, the recorded video clip is between 5-30 seconds, preferably about 20 seconds in length. The recorded video and corresponding sensor data may be received from camera 102 via any wireless or wired communication mechanism.

At operation 704, the threat determination system 126 builds 3-dimensional trees of data for people, backgrounds, objects, and other items recognized from the received video and/or sensor data from camera 102.

At operation 706, threat determination system 126 processes the trees of data and analyzes them via one or more software algorithms to determine a potential threat level to persons or property present at physical space 108 of camera 102. The specific processing operations are discussed in more detail with respect to FIG. 6. At operation 708, an alert is transmitted to user 102 with the determined threat level information.

Optionally, at operation 710, a user may respond to the alert via a user device with a confirmation that it is accurate, a modifier to increase the threat level or decrease the threat level, or a cancellation of the threat alert entirely. Threat determination system 126 may then incorporate the user response to update a current threat level determination, and update its processing of information to determine a different threat level in situations with future similar data. That is, threat determination system 126 continually learns over time to generate more accurate threat level predictions in the future.

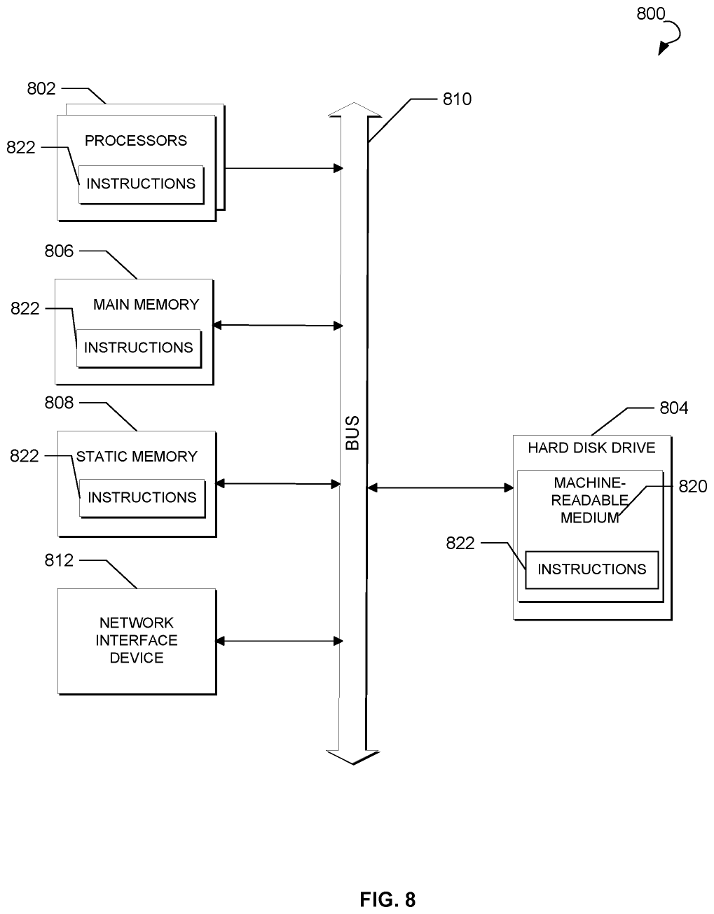

FIG. 8 shows a diagrammatic representation of a computing device for a machine in the exemplary electronic form of a computer system 800, within which a set of instructions for causing the machine to perform any one or more of the methodologies discussed herein can be executed. Computer system 800 may be implemented within camera 102, video analysis system 122, system for facial recognition 124, and/or threat determination system 126.

In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802, a hard disk drive 804, a main memory 806, and a static memory 808, which communicate with each other via a bus 810. The computer system 800 may also include a network interface device 812. The hard disk drive 804 may include a computer-readable medium 820, which stores one or more sets of instructions 822 embodying or utilized by any one or more of the methodologies or functions described herein. The instructions 822 can also reside, completely or at least partially, within the main memory 806 and/or within the processors 802 during execution thereof by the computer system 800. The main memory 806 and the processors 802 also constitute machine-readable media.

While the computer-readable medium 820 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 800 may be implemented as a cloud-based computing environment, such as a virtual machine operating within a computing cloud. In other embodiments, the computer system 800 may itself include a cloud-based computing environment, where the functionalities of the computer system 800 are executed in a distributed fashion. Thus, the computer system 800, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

Thus, computer-implemented methods and systems for continuous detection and recognition for threat determination via a camera system are described herein. Although embodiments have been described herein with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for continuous detection and recognition for threat determination via a camera system, the system comprising:
a camera comprising:
a lens;
at least one sensor;
a first processor and a first memory, configured to:
record video for a predetermined time period; and
transmit the recorded video to a video analysis system in communication with the camera; and
the video analysis system comprising:
a second processor and second memory, the second processor configured to:
receive the transmitted recorded video from the camera;
process the recorded video;
determine a threat level to persons or property in a physical space of the camera; and
transmit an alert to a user of the camera.

2. The camera system of claim 1, wherein the recorded video further comprises audio.

3. The camera system of claim 1, wherein the camera records video for the predetermined time period, in response to detecting a triggering event.

4. The camera system of claim 1, wherein the first processor is a specialized video processor.

5. The camera system of claim 1, wherein the video analysis system further comprises a data structure communicatively coupled to the second processor, the database storing previously identified human faces and associated identity information.

6. The camera system of claim 1, wherein the video analysis system processes the recorded video by processing the recorded video to determine at least two of a background, background activity, human face, human facial expression, and foreground activity.

7. The camera system of claim 1, wherein the video analysis system processes the recorded video by processing recorded video frames in view of at least one of: a time for the recorded video, a motion detected by the camera, and a sound detected by a microphone on the camera.

8. The camera system of claim 1, wherein the predetermined time period for recording video is less than one minute.

9. The camera system of claim 1, wherein the alert transmitted to the user of the camera is at least one of a pop-up message, text message, audio alert, or e-mail message transmitted to a user device of the user.

10. The camera system of claim 1, wherein the video analysis system is further configured to update the determined threat level, in accordance with a response to the alert received from the user.

11. A method for continuous detection and recognition for threat determination via a camera system, the method comprising:
receiving recorded video of a predetermined length of time from a camera;
processing the recorded video to detect and identify a plurality of characteristics;
constructing a plurality of three-dimensional trees of data for the identified plurality of characteristics in the recorded video;
determining a potential threat level to persons or property at the physical space where the camera is located based on the plurality of three-dimensional trees of data; and
transmitting an alert to a user of the camera, the alert comprising the determined potential threat level present.

12. The method of claim 11, wherein the recorded video further comprises audio.

13. The method of claim 11, wherein the recorded video is recorded in response to the camera detecting a triggering event.

14. The method of claim 11, wherein the processing the recorded video further comprises utilizing a data structure with previously identified human faces and associated identity information.

15. The method of claim 11, wherein the plurality of characteristics comprises at least two of a background, background activity, human face, human facial expression, and foreground activity.

16. The method of claim 11, wherein the processing the recorded video occurs in view of at least one of a time for the recorded video, a motion detected by the camera, and a sound detected by a microphone on the camera.

17. The method of claim 11, wherein the alert further comprises a copy of at least a portion of the recorded video.

18. The method of claim 11, wherein the alert transmitted to the user of the camera is at least one of a pop-up message, text message, audio alert, or e-mail message transmitted to a user device of the user.

19. The method of claim 11, further comprising:
receiving a user response to the transmitted alert; and
updating the determined threat level based on the user response.

20. A system for continuous detection and recognition for threat determination via a camera system, the system comprising:
a background determination module that determines a background of a camera in a physical location;
a background activity determination module that determines a background activity of the camera in the physical location;
an event processing module that determines an ongoing event at the physical location of the camera;
an activity processing module that determines a foreground activity of the camera;
an expression evaluation module that determines a facial expression of a person identified from recorded video of the camera; and
a decision tree processing module that determines a threat level present at the physical location of the camera.
